(19) United States
(12) Patent Application Publication
(10) Pub. No.: US 2023/0284215 A1
(43) Pub. Date: Sep. 7, 2023

(54) METHOD AND APPARATUS FOR TRAFFIC IDENTIFIER-BASED UPLINK TRIGGERING OPERATION

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/177,093

(22) Filed: Mar. 1, 2023

Related U.S. Application Data
(60) Provisional application No. 63/316,806, filed on Mar. 4, 2022.

(51) Int. Cl. H04W 72/1268; H04W 72/21; H04W 72/0446

(52) U.S. Cl. CPC H04W 72/1268; H04W 72/21; H04W 72/0446; H04W 84/12

(57) ABSTRACT

Methods and apparatuses for triggering of uplink (UL) transmissions based on traffic identifiers (TIDs) in a wireless local area network. A station (STA) comprises a transceiver and a processor operably coupled to the transceiver. The transceiver is configured to receive, from an access point (AP), a trigger frame that includes an indication that the trigger frame is configured for TID-based triggering of UL transmissions. The processor is configured to identify, based on receipt of the trigger frame, at least one TID for which UL transmission is triggered, determine whether UL traffic corresponding to the at least one TID is ready for transmission, and generate, based on the UL traffic being ready for transmission, a UL physical protocol data unit (PPDU) from the UL traffic. The transceiver is further configured to transmit, to the AP, the UL PPDU.

### CROSS-REFERENCE TO RELATED APPLICATION(S) AND CLAIM OF PRIORITY

This application claims priority under 35 U.S.C. § 119(e) to U.S. Provisional Patent Application No. 63/316,806 filed on Mar. 4, 2022, which is hereby incorporated by reference in its entirety.

### TECHNICAL FIELD

This disclosure relates generally to efficiency in wireless communications systems. Embodiments of this disclosure relate to methods and apparatuses for enabling triggering of uplink transmissions based on traffic identifiers in a wireless local area network communications system.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Target Wake Time (TWT) is one of the important features for power management in WI-FI networks, which was developed by IEEE 802.11ah and later adopted and modified into IEEE 802.11ax. TWT enables wake time negotiation between an AP and an associated station (STA) for improving power efficiency. With TWT operation, it suffices for a STA to only wake up at a pre-scheduled time negotiated with another STA or AP in the network. In IEEE 802.11ax standards, two types of TWT operation are possible—individual TWT operation and broadcast TWT operation. Individual TWT agreements can be established between two STAs or between a STA and an AP. On the other hand, with broadcast TWT operation, an AP can set up a shared TWT session for a group of STAs.

The negotiated parameters such as the wake interval, wake duration and initial wake time (offset) highly affect latency, throughput as well as power efficiency, which are directly related to QoS (quality of service) or customer experiences. Services with different traffic characteristics will have different TWT parameter configurations for better QoS. Additionally, the TWT configuration should adapt to network and service status variation.

Restricted TWT (rTWT) operation, which is based on broadcast TWT operation, is a feature introduced with a view to providing better support for latency sensitive applications. Restricted TWT offers a protected service period for its member STAs by sending Quiet elements to other STAs in the basic service set (BSS) which are not members of the restricted TWT schedule, where the Quiet interval corresponding to the Quiet element overlaps with the initial portion of the restricted TWT service period (SP). Hence, it gives more channel access opportunity for the restricted TWT member scheduled STAs, which supports latency-sensitive traffic flow. There are some key characteristics that make restricted TWT operation an important feature for supporting low-latency applications in next generation WLAN systems.

IEEE 802.11 standards have introduced trigger frames for efficient operation of uplink (UL) and downlink (DL) communication. In a trigger-enabled communication, the UL/DL frame transmission is controlled by the AP. So, the AP can manage the basic service set (BSS) activity better using trigger-enabled physical protocol data unit (PPDU) transmission.

### SUMMARY

Embodiments of the present disclosure provide methods and apparatuses for enabling triggering of UL transmissions based on traffic identifiers (TIDs) in a wireless network (e.g., a WLAN).

In one embodiment, a STA is provided, comprising a transceiver and a processor operably coupled to the transceiver. The transceiver is configured to receive, from an AP, a trigger frame that includes an indication that the trigger frame is configured for TID-based triggering of UL transmissions. The processor is configured to identify, based on receipt of the trigger frame, at least one TID for which UL transmission is triggered, determine whether UL traffic corresponding to the at least one TID is ready for transmission, and generate, based on the UL traffic being ready for transmission, a UL physical PPDU from the UL traffic. The transceiver is further configured to transmit, to the AP, the UL PPDU.

In another embodiment, an AP is provided, comprising a transceiver and a processor operably coupled to the transceiver. The processor is configured to generate a trigger frame that includes an indication that the trigger frame is configured for TID-based triggering of UL transmissions. The transceiver is configured to transmit, to a STA, the trigger frame. Based on receipt of the trigger frame by the STA, at least one TID is identified for which UL transmission is triggered, it is determined whether UL traffic corresponding to the at least one TID is ready for transmission, and based on the UL traffic being ready for transmission, a UL PPDU is generated from the UL traffic. The transceiver is further configured to receive, from the STA, the UL PPDU.

In another embodiment, a method performed by the STA is provided, including the steps of receiving, from an AP, a trigger frame that includes an indication that the trigger frame is configured for TID-based triggering of UL transmissions, identifying, based on receipt of the trigger frame, at least one TID for which UL transmission is triggered, determining whether UL traffic corresponding to the at least one TID is ready for transmission, generating, based on the UL traffic being ready for transmission, a UL PPDU from the UL traffic, and transmitting, to the AP, the UL PPDU.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example of use of a trigger frame in the context of multi-user operation in a WLAN according to various embodiments of the present disclosure;

FIG. 4 illustrates an example format of the User Info field of the UL-TID Trigger frame according to various embodiments of the present disclosure;

FIG. 5 illustrates another example format of the User Info field of the UL-TID Trigger frame according to various embodiments according to various embodiments of the present disclosure;

FIG. 6 illustrates an example format of the User Info field of the UL-TID Trigger frame containing a Preferred TID Present subfield according to various embodiments of the present disclosure;

FIG. 7 illustrates an example of use of a UL-TID Trigger frame in a multi-user setting without the Preferred TID subfield according to various embodiments of the present disclosure;

FIG. 8 illustrates an example of use of UL-TID Trigger frame without the Preferred TID subfield subsequent to use of UL-TID Trigger frame with the Preferred TID subfield according to various embodiments of the present disclosure;

FIG. 9 illustrates an example use of a UL-TID Trigger frame without the Preferred TID subfield to solicit a BSR according to various embodiments of the present disclosure;

FIG. 10 illustrates an example format of the User Info field of the UL-TID Trigger frame including the Preferred TID Bitmap subfield according to various embodiments of the present disclosure;

FIG. 11 illustrates another example format of the User Info field of the UL-TID Trigger frame including the Preferred TID Bitmap subfield according to various embodiments of the present disclosure;

FIG. 12 illustrates an example format of the User Info field of the UL-TID Trigger frame containing a Preferred TID Bitmap Present subfield according to various embodiments of the present disclosure;

FIG. 13 illustrates an example of use of UL-TID Trigger frames in broadcast (and restricted) TWT operation according to various embodiments of the present disclosure;

FIG. 14 illustrates an example of use of UL-TID Trigger frame for restricted TWT operation where the r-TWT scheduling AP triggers multiple TIDs negotiated for the r-TWT schedule using the User Info field and Common Info field according to various embodiments of the present disclosure;

FIG. 15 illustrates an example of use of a UL-TID Trigger frame for the uplink random access procedure according to various embodiments of the present disclosure;

FIG. 16 illustrates an example format of the User Info field of the UL-TID Trigger frame including a User BSR Requested subfield according to various embodiments of the present disclosure;

FIG. 17 illustrates an example format of the Common Info field of the UL-TID Trigger frame including a BSR Requested subfield according to various embodiments of the present disclosure;

FIG. 18 illustrates another example format of the Common Info field of the UL-TID Trigger frame according to various embodiments of the present disclosure;

FIG. 19 illustrates another example format of the Common Info field of the UL-TID Trigger frame according to various embodiments of the present disclosure;

FIG. 20 illustrates an example of using a UL-TID Trigger frame for r-TWT operation using User Info field and Common Info field to indicate the triggered TIDs according to various embodiments of the present disclosure;

FIG. 21 illustrates an example of using a UL-TID Trigger frame in the context of restricted TWT operation and BSR solicitation according to various embodiments of the present disclosure;

FIG. 22 illustrates an example process for the use of UL-TID Trigger frame including BSR solicitation according to various embodiments of the present disclosure; and

FIG. 23 illustrates an example process for TID-based triggering of uplink transmissions according to various embodiments of the present disclosure.

### DETAILED DESCRIPTION

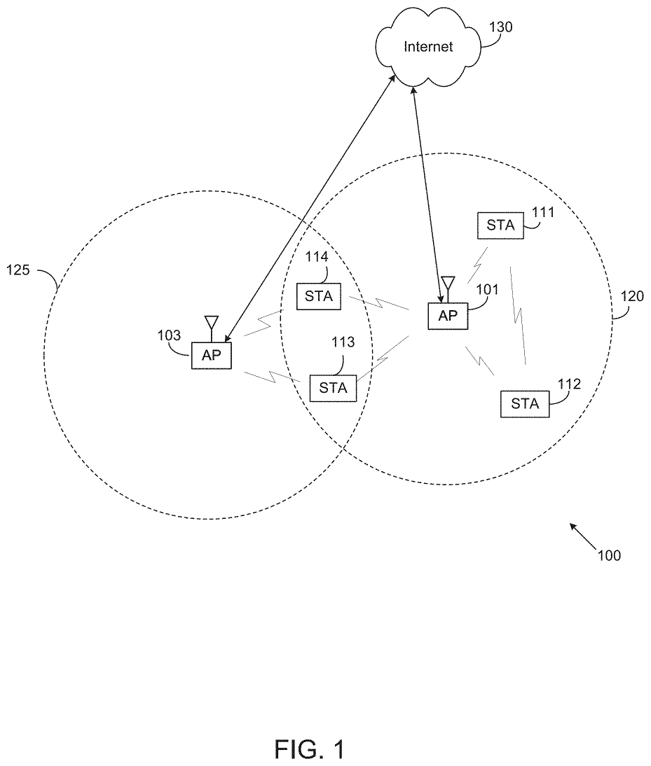

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

According to the current standards, an AP can trigger a non-AP STA with a Trigger frame. From a quality of service (QoS) perspective, in the Trigger frame, the AP can indicate the preferred access category (AC) for the uplink transmission by indicating the AC in the Preferred AC subfield of the User Info field of the Trigger frame corresponding to the STA that is being triggered. According to the current specification, there is no mechanism available to the AP to trigger a STA for per-TID-based PPDU transmission (where TID denotes traffic identifier). However, embodiments of the present disclosure recognize that the capability for TID-based PPDU triggering can be extremely useful for various applications such as, for example, latency-sensitive applications.

Embodiments of the present disclosure further recognize that a restricted TWT (r-TWT) schedule is set up on a per-TID basis and, accordingly, for trigger-enabled restricted TWT the AP should have a mechanism to trigger uplink transmission from a member r-TWT scheduled STA based on the TID corresponding to its latency-sensitive traffic. However, a mechanism to only trigger uplink PPDUs corresponding to latency-sensitive traffic is currently not present in the specification. Accordingly, embodiments of the present disclosure provide mechanisms and frameworks for enabling per-TID-based triggering of uplink transmissions, particularly during TWT and r-TWT operation.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating triggering of uplink transmissions based on TIDs in a WLAN. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

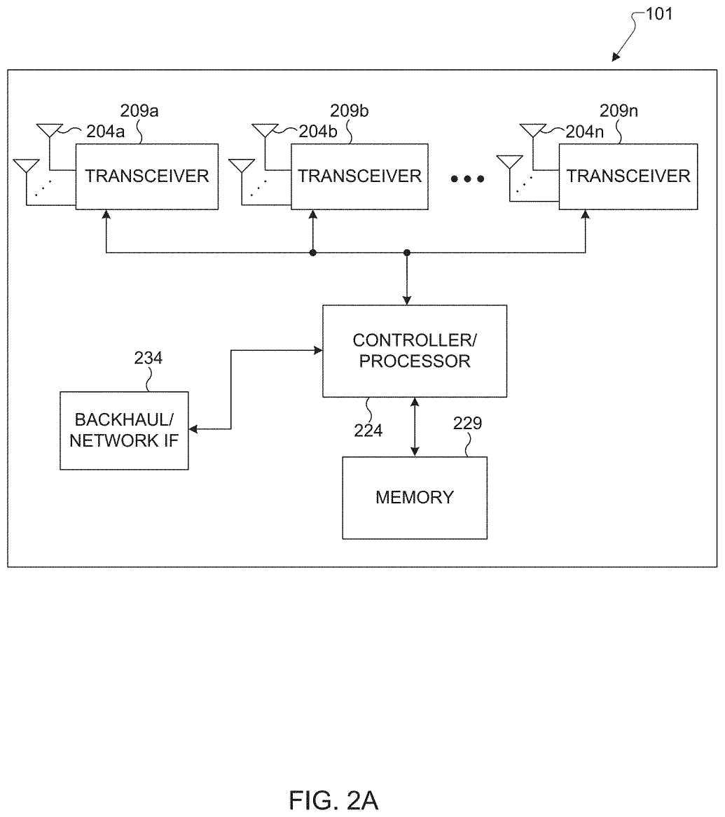

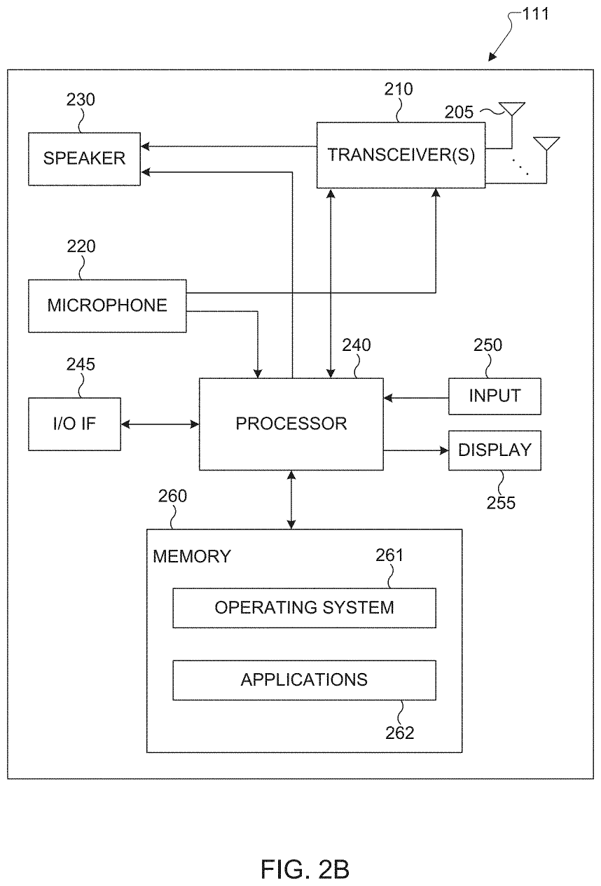

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating triggering of uplink transmissions based on TIDs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating triggering of uplink transmissions based on TIDs. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives, from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate triggering of uplink transmissions based on TIDs. In some embodiments, the processor 240 includes at least one microprocessor or microcontroller.

The processor 240 is also capable of executing other processes and programs resident in the memory 260, such as operations for facilitating triggering of uplink transmissions based on TIDs. The processor 240 can move data into or out of the memory 260 as required by an executing process. In some embodiments, the processor 240 is configured to execute a plurality of applications 262, such as applications for facilitating triggering of uplink transmissions based on TIDs. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

According to various embodiments of the present disclosure, in order to enable P2P communication during a TWT SP using Triggered TXOP sharing, a multi-user request to send (MU-RTS) TXS Mode 2-enabled TWT schedule (or agreement) is defined, where MU-RTS TXS Mode 2 is a TXOP sharing mode in which a STA is allowed to perform UL communications with the AP and P2P communications with a peer STA. A TWT SP corresponding to an MU-RTS TXS Mode 2-enabled TWT schedule or agreement is a trigger-enabled TWT SP where the TWT responding AP or the TWT scheduling AP triggers the TWT requesting STA or TWT scheduled STA by sending an MU-RTS TXS Trigger frame (TF) with a Triggered TXOP Sharing Mode subfield in the Common Info field of the MU-RTS TXS Trigger frame set to 2 (an “MU-RTS TXS (Mode 2) Trigger frame”) during that TWT SP.

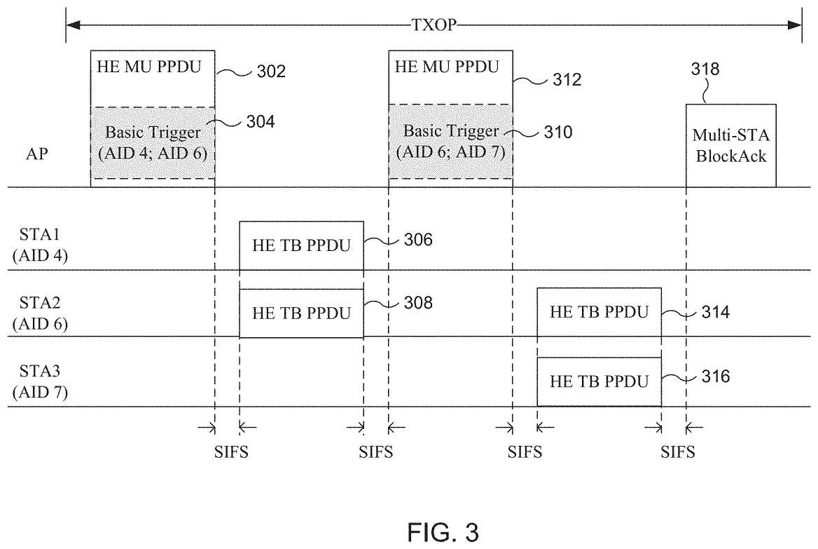

FIG. 3 illustrates an example of use of a trigger frame in the context of multi-user operation in a WLAN according to various embodiments of the present disclosure. In the example of FIG. 3, three STAs—STA1, STA2, and STA3—are associated with the AP. In the example of FIG. 3, the AP may be AP 101, and the STAs 1-3 may be STAs 111-113. STA1 has association ID (AID) 4, STA2 has AID 6, and STA 3 has AID 7.

Upon winning the transmit opportunity (TXOP), the AP sends a high-efficiency multi-user physical protocol data unit (HE MU PPDU) 302 and includes a Basic Trigger frame 304 in the PPDU 302. In the Basic Trigger frame 304, the AP includes two User Info fields in the User Info List field. The AID12 subfield of the first User Info field is set to value 4 (e.g., to trigger STA1) and the AID12 subfield of the second User Info field is set to value 6 (e.g., to trigger STA2).

A short interframe space (SIFS) duration after the transmission of the HE MU PPDU 302, STA1 and STA2 send uplink HE trigger-based (TB) PPDUs 306 and 308, respectively, to the AP. Upon reception of the HE TB PPDUs 306 and 308 from STA1 and STA2, the AP, after a SIFS duration, sends another trigger frame 310 encapsulated in the HE MU PPDU 312 with two User Info fields corresponding to AID 6 (e.g., to trigger STA2) and AID 7 (e.g., to trigger STA3). Accordingly, after another SIFS duration, STA2 and STA3 send their HE TB PPDUs 314 and 316, respectively, to the AP. Finally, the AP acknowledges the reception of the HE TB PPDUs 314 and 316 from STA2 and STA3 by sending a Multi-STA BlockAck frame 318.

As noted above, it would be beneficial for an AP to be able to trigger a STA to transmit UL PPDUs to the AP based on TIDs of traffic that is ready at the STA since not all traffic is equal. Merely triggering a STA based on its AID may not allow the AP to ensure that high priority traffic (such as latency-sensitive traffic) is served before lower priority traffic (such as latency-tolerant traffic). Accordingly, various embodiments of the present disclosure provide examples of a trigger frame that can trigger a STA for UL PPDU transmission on a per-TID basis. Such as trigger frame is referred to as a UL-TID Trigger frame. Embodiments of the present disclosure also provide various examples of formats for the User Info field of the UL-TID Trigger frame. Further embodiments of the present disclosure provide methods for an AP to trigger uplink transmission from a member r-TWT scheduled STA based on the TID corresponding to its latency-sensitive traffic.

According to one embodiment, a new variant of Trigger frame, namely, a UL-TID Trigger frame, is introduced that can trigger a STA for UL PPDU transmission on a per-TID basis. Table I below shows an example of Trigger Type subfield encoding for a UL-TID Trigger frame. As shown in Table I, a Trigger Type subfield value of 8 is used for indicating that a Trigger frame is a UL-TID Trigger frame. According to another embodiment, other values from 9-15 may also be used to indicate a UL-TID Trigger frame.

TABLE I

| Trigger Type | |
|---|---|
| subfield value | Trigger frame variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8 | UL-TID |
| 9-15 | Reserved |

Based on current 802.11 specifications, the presence of the Trigger-dependent User Info field in the User Info field of a Trigger frame depends on the type of Trigger frame, while other fields in the User Info field are common for all types of Trigger frame. So, any Trigger-type-specific fields can be accommodated in the Trigger Dependent User Info field. According to one embodiment, the Trigger Dependent User Info field is present in the User Info field of the UL-TID Trigger frame, as shown in the various examples below.

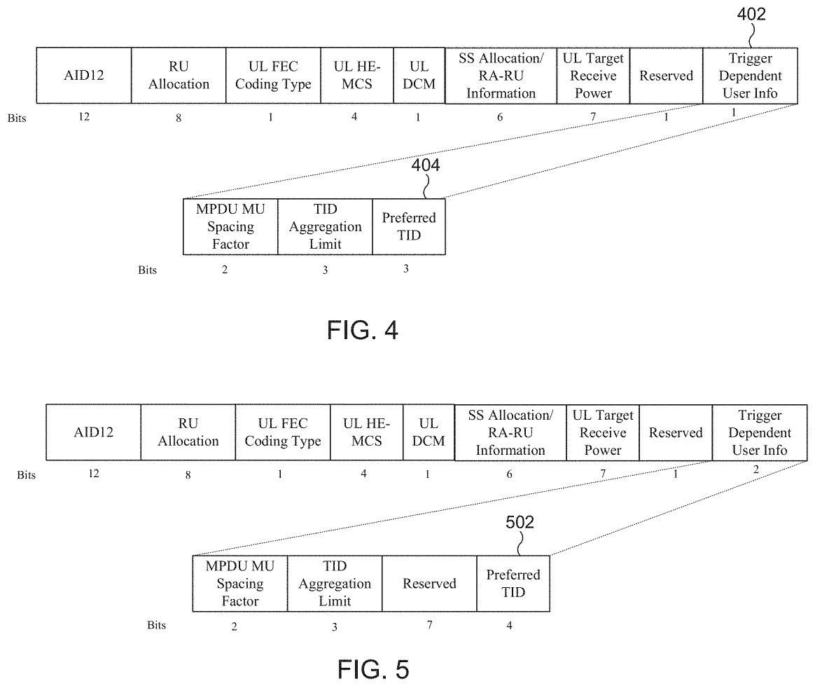

FIG. 4 illustrates an example format of the User Info field of the UL-TID Trigger frame according to various embodiments of the present disclosure. The Trigger Dependent User Info field 402 can contain subfields, including a MAC Protocol Data Unit multi-user (MPDU MU) Spacing Factor subfield, a TID Aggregation Limit subfield and a Preferred TID subfield 404. The definitions of the MPDU MU Spacing Factor subfield and the TID Aggregation Limit subfield in the Trigger Dependent User Info field can be the same as those of the Basic Trigger frame.

The Preferred TID subfield 404 in the Trigger Dependent User Info field 402 in the UL-TID Trigger frame indicates the preferred TID for which the AP is triggering the STA for UL transmission using the UL-TID Trigger frame. According to one embodiment, the Preferred TID subfield 404 is 3 bits long as shown in FIG. 4. According to this embodiment, only one of the first 8 TIDs (TID 0 to TID 7) can be triggered. This is in congruence with the TID negotiation procedure for an r-TWT Setup.

FIG. 5 illustrates another example format of the User Info field of the UL-TID Trigger frame according to various embodiments according to various embodiments of the present disclosure. According to the embodiment of FIG. 5, the Preferred TID subfield 502 is 4 bits long. According to this embodiment, any of the 16 TIDs can be triggered using the UL-TID Trigger frame.

According to one embodiment, the TID indicated in the Preferred TID subfield is a “preferred” TID, meaning that the AP recommends the triggered STA to only send a UL trigger-based (TB) PPDU corresponding to the TID indicated in the Preferred TID subfield of the UL-TID Trigger frame. According to this embodiment, the triggered STA may still transmit UL PPDUs corresponding to TIDs that are not indicated in the Preferred TID subfield. This behavior can be allowed when the triggered STA does not have a UL TB PPDU corresponding to the TID indicated in the Preferred TID subfield (for example, when there is no such traffic in the STA's buffer to send, or the UL TB PPDU cannot be prepared by the STA in time). The reception by the AP of a UL PPDU corresponding to a TID that is not indicated in the Preferred TID subfield can also serve as the indication to the AP that the triggered STA does not have a UL TB PPDU corresponding to the TID indicated in the Preferred TID subfield, and therefore the AP may not transmit another UL-TID Trigger frame to the STA for the same TID.

According to another embodiment, if an AP triggers a non-AP STA with a UL-TID Trigger frame that contains the Preferred TID subfield in the User Info field, then the triggered STA does not transmit a UL TB PPDU corresponding to a TID that is not indicated in the Preferred TID subfield of the User Info field. In the case where no TIDs are listed in the Preferred TID subfield, the triggered STA may still send an acknowledgement frame or other management frame acknowledging the reception of the UL-TID Trigger frame.

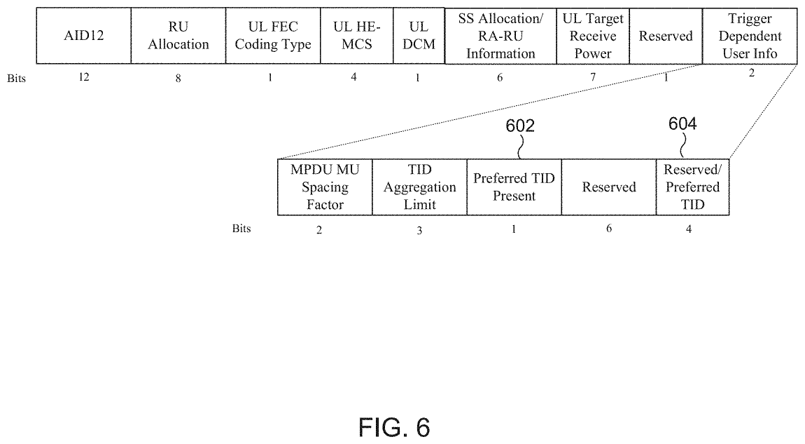

FIG. 6 illustrates an example format of the User Info field of the UL-TID Trigger frame containing a Preferred TID Present subfield according to various embodiments of the present disclosure. According to this embodiment, the Preferred TID subfield is only optionally present in the User Info field of the UL-TID Trigger frame. The presence of the Preferred TID subfield can be indicated in the Preferred TID Present subfield 602 of the Trigger Dependent User Info field of the User Info field. If the Preferred TID Present subfield 602 is set to 1, it indicates that Preferred TID subfield is present in the Trigger Dependent User Info field of the User Info field of the UL-TID Trigger frame. Otherwise, the Preferred TID subfield is not present in the User Info field.

According to one embodiment, in reference to FIG. 6, if the Preferred TID Present subfield 602 in the User Info field is set to 1, then the last 4 bits 604 of the Trigger Dependent User Info field of the User Info field contain the Preferred TID subfield. If the Preferred TID Present subfield 602 is set to 0, then the last 4 bits 604 of the Trigger Dependent User Info field of the User Info field of the UL-TID Trigger frame are reserved.

According to one embodiment, if the Preferred TID subfield is not present in the User Info field of the UL-TID Trigger frame, then it indicates that there is no preference for any TID for UL PPDU transmission, and the triggered non-AP STA may send UL TB PPDUs corresponding to any TID.

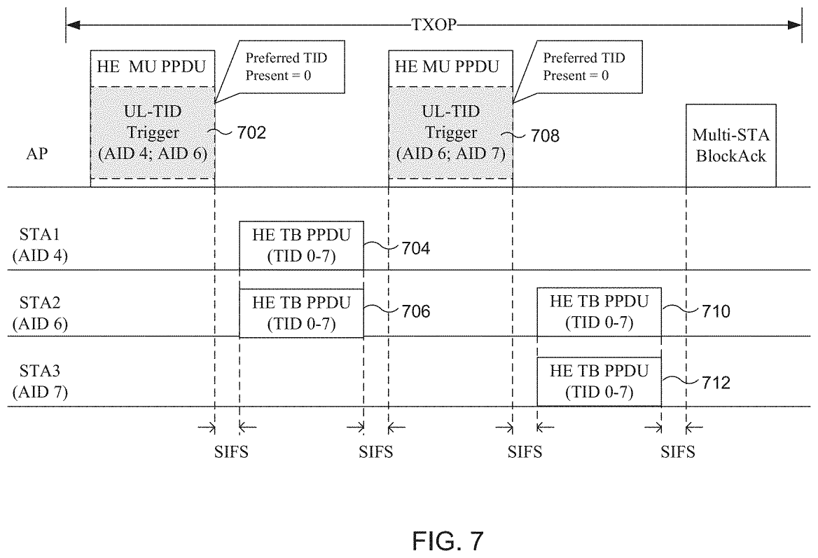

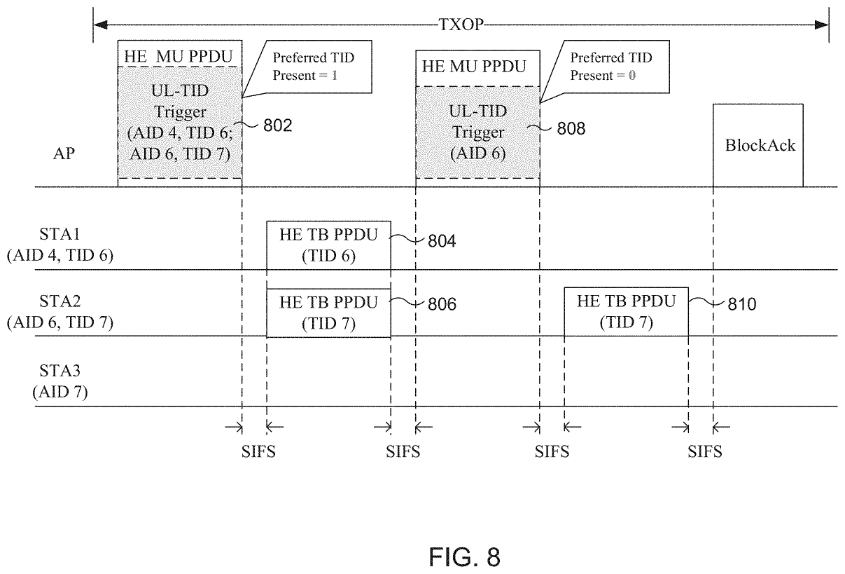

FIG. 7 illustrates an example of use of a UL-TID Trigger frame in a multi-user setting without the Preferred TID subfield according to various embodiments of the present disclosure. In FIG. 7, three STAs—STA1, STA2, and STA3—are associated with the AP. STA1 has AID 4, STA2 has AID 6, and STA 3 has AID 7.

Upon winning the TXOP, the AP sends an HE MU PPDU and includes a UL-TID Trigger frame 702 in the PPDU. In the UL-TID Trigger frame 702, the AP includes two User Info fields in the User Info List field. The AID12 subfield of the first User Info field is set to value 4 and the AID12 subfield of the second User Info field is set to value 6. No Preferred TID subfield is included in the UL-TID Trigger frame 702.

A SIFS duration after the transmission of the HE MU PPDU, STA1 and STA2 send respective uplink HE TB PPDUs 704 and 706 to the AP. In this uplink transmission, there is no restriction on the TIDs, and the transmission may include any of the TIDs. Upon reception of the HE TB PPDUs 704 and 706 from STA1 and STA2, the AP, after a SIFS duration, sends another UL-TID Trigger frame 708 encapsulated in an HE MU PPDU with two User Info fields corresponding to AID 6 and AID 7. In this trigger frame as well, the Preferred TID subfield is not included. Accordingly, after another SIFS duration, STA2 and STA3 send their HE TB PPDUs 710 and 712 to the AP—their transmissions are not restricted to any particular TIDs. Finally, the AP acknowledges the reception of the HE TB PPDUs 710 and 712 from STA2 and STA3 by sending a Multi-STA BlockAck frame.

According to another embodiment, if a Preferred TID subfield in the User Info field of a UL-TID Trigger frame was received by the non-AP STA previously, and if the Preferred TID subfield is not present in the User Info field of a newly received UL-TID Trigger frame, then it indicates that the triggered non-AP STA may only send UL TB PPDUs corresponding to TIDs that were indicated in the Preferred TID subfield in the User Info field of the UL-TID Trigger frame that was most recently received by that non-AP STA.

FIG. 8 illustrates an example of use of UL-TID Trigger frame without the Preferred TID subfield subsequent to use of UL-TID Trigger frame with the Preferred TID subfield according to various embodiments of the present disclosure. In FIG. 8, three STAs—STA1, STA2, and STA3—are associated with the AP. STA1 has AID 4, STA2 has AID 6, and STA 3 has AID 7.

Upon winning the TXOP, the AP sends the HE MU PPDU and includes a UL-TID Trigger frame 802 in the PPDU. In the UL-TID Trigger frame 802, the AP includes two User Info fields in the User Info List field. The AID12 subfield of the first User Info field is set to value 4 and the AID12 subfield of the second User Info field is set to value 6. In the UL-TID Trigger frame 802, the AP indicates TID 6 in the Preferred TID subfield in the User Info field corresponding to AID 4, and indicates TID 7 in the Preferred TID subfield in the User Info field corresponding to AID 6.

A SIFS duration after the transmission of the HE MU PPDU, STA1 and STA2 send uplink HE TB PPDUs 804 and 806 to the AP, respectively. In this transmission, STA1 sends uplink traffic corresponding to TID 6 and STA2 sends uplink traffic corresponding to TID 7. Upon reception of the HE TB PPDUs 804 and 806 from STA1 and STA2, the AP, after a SIFS duration, sends another UL-TID Trigger frame 808 encapsulated in an HE MU PPDU with two User Info fields corresponding to AID 6 and AID 7. In this trigger frame, the Preferred TID subfield is not included in the User Info field. Accordingly, after another SIFS duration, STA2 sends its HE TB PPDU 810 to the AP—the transmission is restricted to only TID 7 since in the last UL-TID Trigger frame received by STA2, the TID indicated in the Preferred TID subfield was 7. Finally, the AP acknowledges the reception of the HE TB PPDU 810 from STA2 by sending a BlockAck frame.

According to one embodiment, within a given TXOP at least the first UL-TID Trigger frame needs to contain the Preferred TID subfield if a subsequently transmitted UL-TID Trigger frame within the same TXOP does not contain the Preferred TID subfield. According to another embodiment, the first UL-TID Trigger frame containing the Preferred TID subfield can be from a previous TXOP and all the UL-TID Trigger frames in a subsequent TXOP may still not have any Preferred TID subfield.

According to another embodiment, if the Preferred TID subfield is not present in the User Info field of the UL-TID Trigger frame, then it indicates that the triggered non-AP STA needs to send a Buffer Status Report (BSR) corresponding to all the TIDs to the AP. According to this embodiment, the transmitted BSR is on a per-TID basis.

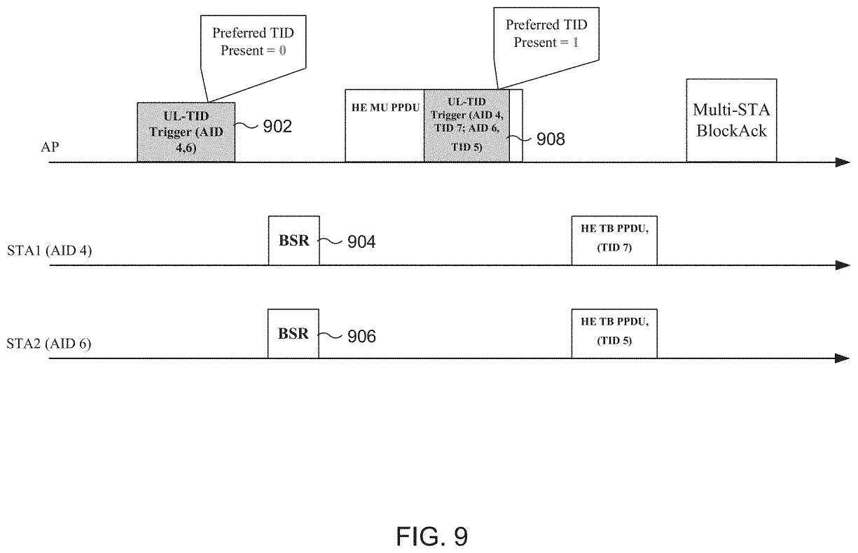

FIG. 9 illustrates an example use of a UL-TID Trigger frame without the Preferred TID subfield to solicit a BSR according to various embodiments of the present disclosure. In FIG. 9, two STAs—STA1 and STA2—are associated with the AP. STA1 has AID 4 and STA2 has AID 6.

Upon winning the TXOP, the AP sends an HE MU PPDU and includes a UL-TID Trigger frame 902 in the PPDU. In the UL-TID Trigger frame 902, the AP includes two User Info fields in the User Info List field. The AID12 subfield of the first User Info field is set to value 4 and the AID12 subfield of the second User Info field is set to value 6. The AP does not include any Preferred TID subfield in any of the User Info fields—this indicates a solicitation of BSR from the triggered STAs.

A SIFS duration after the transmission of the HE MU PPDU, the STA1 and STA2 send BSRs 904 and 906, respectively, corresponding to all the TIDs. In the BSRs, STA1 indicates that it has non-zero buffer corresponding to TID 7 and STA2 indicates that it has non-zero buffer corresponding to TID 5. Upon receiving the BSRs 904 and 906, the AP triggers STA1 and STA2 for uplink transmission corresponding to TID 7 and TID 5, respectively, with another UL-TID Trigger frame 908.

According to another embodiment, if the Preferred TID subfield is not present in the User Info field of the UL-TID Trigger frame, then it indicates that the triggered non-AP STA needs to send the Buffer Status Report (BSR) to the AP corresponding only to the TIDs for which it has non-zero buffer, in order to save overhead.

According to one embodiment, in reference to the previously explained embodiments, TID indication in the UL-TID Trigger frame can be performed by including a bitmap indicating the TIDs corresponding to which uplink frames are solicited. For example, a Preferred TID Bitmap subfield can be included in the UL-TID Trigger frame enabling triggering of STAs for frames corresponding to multiple indicated TIDs. If the k-th bit position in the Preferred TID Bitmap subfield is set to 1, it indicates that the triggered non-AP STA can send uplink traffic corresponding to TID k. If the k-th bit position in the Preferred TID Bitmap subfield is set to 0, it indicates that the triggered non-AP STA is not recommended to send uplink traffic corresponding to TID k.

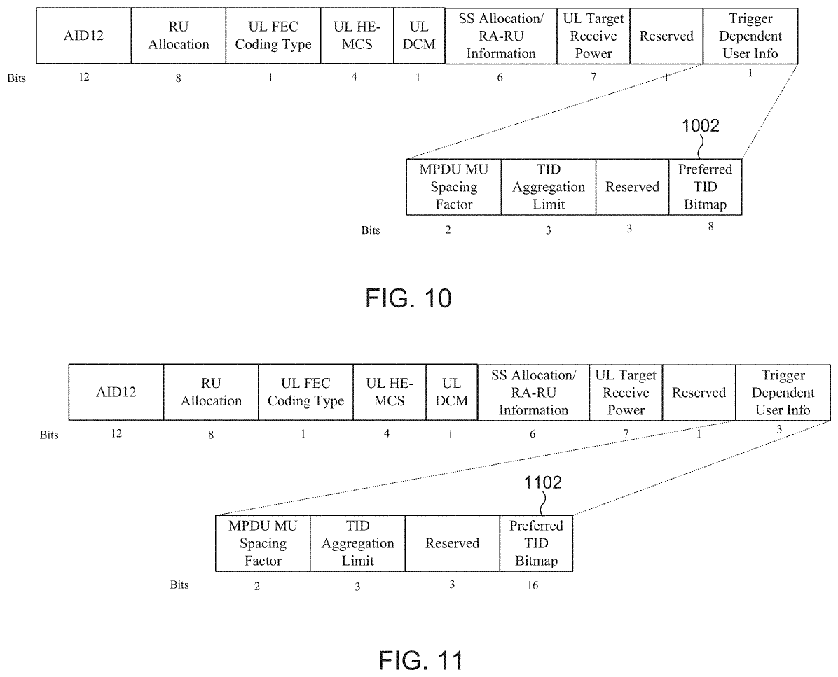

FIG. 10 illustrates an example format of the User Info field of the UL-TID Trigger frame including the Preferred TID Bitmap subfield according to various embodiments of the present disclosure. In the example of FIG. 10, the Preferred TID Bitmap subfield 1002 is 8 bits long. According to this embodiment, only one of the first 8 TIDs (TID 0 to TID 7) can be triggered.

FIG. 11 illustrates another example format of the User Info field of the UL-TID Trigger frame including the Preferred TID Bitmap subfield according to various embodiments of the present disclosure. In the example of FIG. 11, the Preferred TID Bitmap subfield 1102 is 16 bits long. According to this embodiment, any of the 16 TIDs can be triggered.

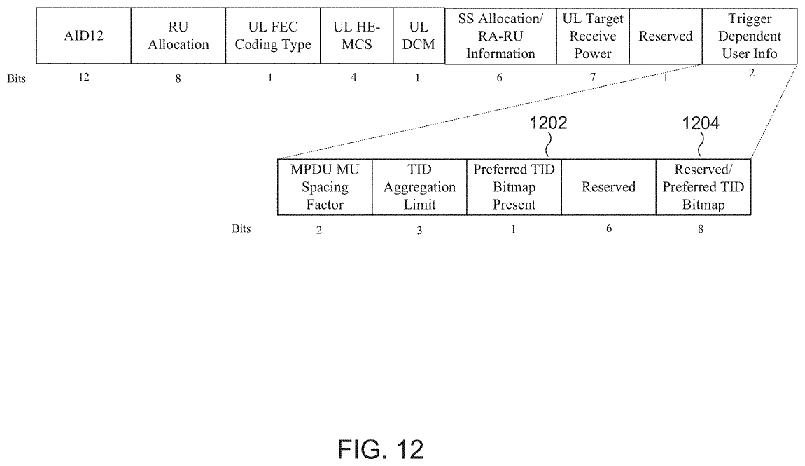

FIG. 12 illustrates an example format of the User Info field of the UL-TID Trigger frame containing a Preferred TID Bitmap Present subfield according to various embodiments of the present disclosure. According to this embodiment, the Preferred TID Bitmap subfield is only optionally present in the User Info field of the UL-TID Trigger frame. The presence of the Preferred TID Bitmap subfield can be indicated in the Preferred TID Bitmap Present subfield 1202 of the Trigger Dependent User Info field of the User Info field. If the Preferred TID Bitmap Present subfield 1202 is set to 1, it indicates that Preferred TID Bitmap subfield is present in the Trigger Dependent User Info field of the User Info field of the UL-TID Trigger frame. Otherwise, the Preferred TID Bitmap subfield is not present in the User Info field.

According to one embodiment, in reference to FIG. 12, if the Preferred TID Bitmap Present subfield 1202 in the User Info field is set to 1, then the last 8 bits 1204 of the Trigger Dependent User Info field of the User Info field contain the Preferred TID Bitmap subfield. If the Preferred TID Bitmap Present subfield 1202 is set to 0, then the last 4 bits 1204 of the Trigger Dependent User Info field of the User Info field of the UL-TID Trigger frame are reserved.

Embodiments of the disclosure presented below recognize that restricted TWT operation can be more effective with the UL-TID Trigger frame. During restricted TWT negotiation, the r-TWT scheduling AP and the r-TWT scheduled STA negotiate the TIDs for which transmissions are allowed during the corresponding r-TWT SP. For Trigger-enabled restricted TWT (or Trigger-enabled broadcast TWT), however, the TWT scheduling AP does not have a mechanism according to the present standard to trigger a scheduled STA for a particular TID only. Although the embodiments below are discussed with reference to Trigger-enabled restricted TWT, it is understood that these embodiments may be used with Trigger-enabled broadcast TWT as well.

According to one embodiment, for restricted TWT operation between an r-TWT scheduling AP and a member r-TWT scheduled STA, if the r-TWT schedule is a Trigger-enabled TWT schedule, then the r-TWT scheduling AP, during the r-TWT SP, triggers a member r-TWT scheduled STA using the UL-TID Trigger frame.

According to one embodiment, during the r-TWT SP the r-TWT scheduling AP, in the UL-TID Trigger frame that it uses for triggering the member r-TWT scheduled STA, only indicates a TID in the Preferred TID subfield (if present) that is within the set of TIDs that are negotiated for the corresponding restricted TWT schedule. According to this embodiment, an r-TWT scheduling AP can trigger only 1 TID at a time using a UL-TID Trigger frame during the r-TWT SP.

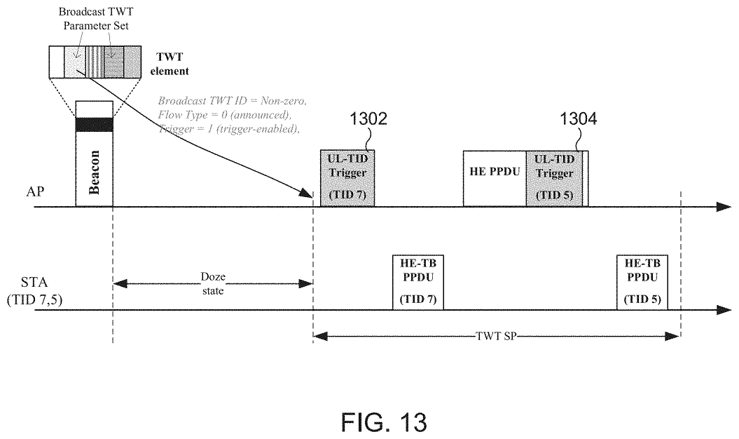

FIG. 13 illustrates an example of use of UL-TID Trigger frames in broadcast (and restricted) TWT operation according to various embodiments of the present disclosure. In the example of FIG. 13, the AP may be AP 101 and is a TWT scheduling AP or TWT responding AP, and the STA may be STA 111 and is a TWT scheduled STA or a TWT requesting STA. The AP and the STA have established a trigger-enabled broadcast TWT schedule, which in this case is also a restricted TWT schedule, and therefore the AP is an r-TWT scheduling AP and the STA is a member r-TWT scheduled STA. During negotiation of the trigger-enabled restricted TWT schedule, TIDs 5 and 7 were negotiated for transmission during the associated trigger-enabled r-TWT SP.

As illustrated in FIG. 13, the r-TWT scheduling AP triggers the member r-TWT scheduled STA during the trigger-enabled r-TWT SP using UL-TID Trigger frame 1302 that indicates TID 7 in its Preferred TID subfield. The member r-TWT scheduled STA has uplink traffic corresponding to TID 7, and accordingly sends an uplink HE TB PPDU including the uplink traffic corresponding to TID 7. The r-TWT scheduling AP also triggers the member r-TWT scheduled STA during the r-TWT SP using UL-TID Trigger frame 1304 that indicates TID 5 in its Preferred TID subfield. The member r-TWT scheduled STA has uplink traffic corresponding to TID 5, and accordingly sends an uplink HE TB PPDU including the uplink traffic corresponding to TID 5.

According to one embodiment, during the r-TWT SP the r-TWT scheduling AP, in the UL-TID Trigger frame that it uses for triggering the member r-TWT scheduled STA, can indicate multiple TIDs in the Preferred TID Bitmap subfield (if present) that are within the set of TIDs that are negotiated for the corresponding restricted TWT schedule. According to this embodiment, an r-TWT scheduling AP can trigger multiple TIDs at a time during the r-TWT SP.

According to one embodiment, the Preferred TID subfield or Preferred TID Bitmap subfield can be included in the Common Info field of the UL-TID Trigger frame to indicate the TIDs corresponding to the traffic for which the STAs have been triggered by this UL-TID Trigger frame. According to one such embodiment, if the Preferred TID subfield or Preferred TID Bitmap subfield is present in the Trigger Dependent Common Info field of the UL-TID Trigger frame, then the Preferred TID subfield or Preferred TID Bitmap subfield is not present in the User Info fields of the UL-TID Trigger frame.

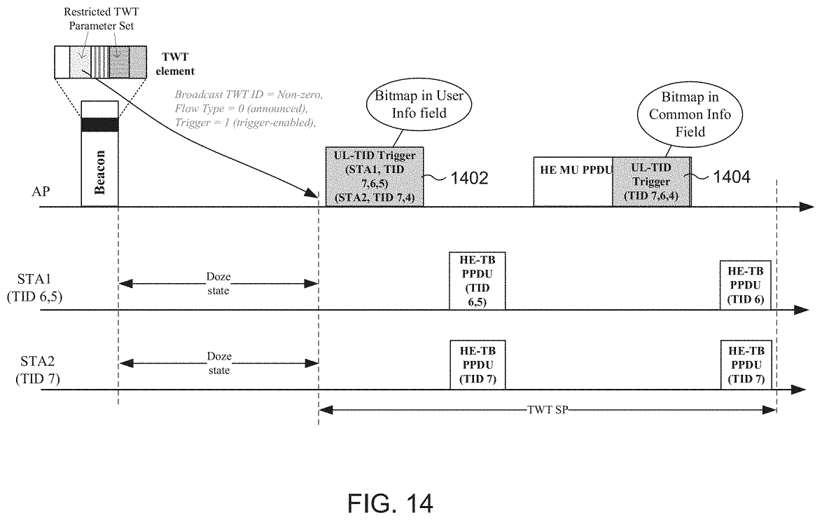

FIG. 14 illustrates an example of use of UL-TID Trigger frame for restricted TWT operation where the r-TWT scheduling AP triggers multiple TIDs negotiated for the r-TWT schedule using the User Info field and Common Info field according to various embodiments of the present disclosure. In the example of FIG. 14, the AP may be AP 101 and is an r-TWT scheduling AP, and the STAs may be STAs 111-112 and are member r-TWT scheduled STAs—the AP and the STAs have established a trigger-enabled restricted TWT schedule. During negotiation of the restricted TWT schedule, TIDs 4, 5, 6, and 7 were negotiated for transmission during the associated trigger-enabled r-TWT SP.

As illustrated in FIG. 14, the r-TWT scheduling AP triggers the member r-TWT scheduled STAs during the trigger-enabled r-TWT SP using UL-TID Trigger frame 1402 that indicates TIDs 7, 6, and 5 in a Preferred TID Bitmap subfield of a User Info field that identifies STA1 with its AID12 subfield, and indicates TIDs 7 and 4 in a Preferred TID Bitmap subfield of a User Info field that identifies STA2 with its AID12 subfield. STA1 has uplink traffic corresponding to TIDs 6 and 5, and accordingly sends an HE TB PPDU containing the uplink traffic corresponding to TIDs 6 and 5. STA2 has uplink traffic corresponding to TID 7, and accordingly sends an HE TB PPDU containing the uplink traffic corresponding to TID 7.

The r-TWT scheduling AP then triggers the member r-TWT scheduled STAs during the r-TWT SP using UL-TID Trigger frame 1404 that indicates TIDs 7, 6, and 4 in a Preferred TID Bitmap subfield of the Common Info field. STA1 has uplink traffic corresponding to TID 6 and 5, and accordingly sends an HE TB PPDU containing the uplink traffic corresponding to TID 6. STA2 has uplink traffic corresponding to TID 7, and accordingly sends an HE TB PPDU containing the uplink traffic corresponding to TID 7.

According to one embodiment, a UL-TID Trigger frame can also be used to enable triggering a STA on a per-TID basis during the uplink random access procedure. According to this embodiment, an AP, while triggering the STA with a UL-TID Trigger frame, can indicate the TID along with the RU for uplink transmission.

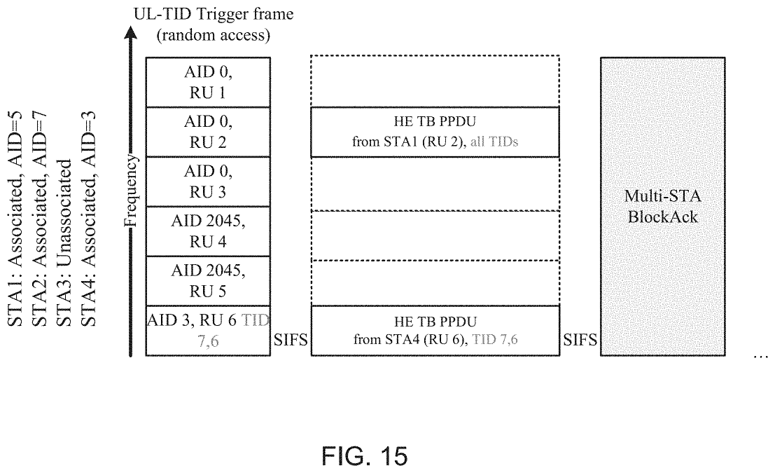

FIG. 15 illustrates an example of use of a UL-TID Trigger frame for the uplink random access procedure according to various embodiments of the present disclosure. As illustrated in FIG. 15, a UL-TID Trigger frame can be sent by the AP during the uplink random access procedure with RUs and preferred TIDs corresponding to AIDs. In some embodiments, if no preferred TIDs are indicated as associated with an RU in the UL-TID Trigger frame, then uplink traffic corresponding to all TIDs may be sent on the RU. In some embodiments, if one or more preferred TIDs are indicated as associated with an RU in the UL-TID Trigger frame, then only uplink traffic corresponding to the indicated TIDs may be sent on the RU.

According to one embodiment, a UL-TID Trigger frame can also be used to solicit a BSR from the triggered STA. According to one embodiment, the buffer status report solicitation can be performed on a per-STA basis. The UL-TID Trigger frame may allow the indication of the request for a BSR by introducing the User BSR Request subfield.

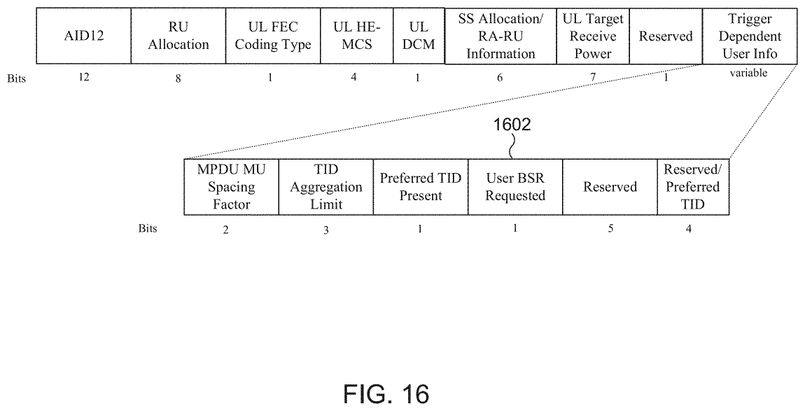

FIG. 16 illustrates an example format of the User Info field of the UL-TID Trigger frame including a User BSR Requested subfield according to various embodiments of the present disclosure. According to one embodiment, in reference to FIG. 16, if the User BSR Requested subfield 1602 in the Trigger Dependent User Info field is set to 1, it indicates that the triggering AP solicits a BSR from the triggered STA identified by the AID12 subfield of the User Info field. If the User BSR Requested subfield 1602 in the Trigger Dependent User Info field is set to 0, it indicates that the triggering AP does not solicit a BSR from the triggered STA identified by the AID12 subfield of the User Info field.

According to another embodiment, an indication can be made in the UL-TID Trigger frame to solicit a BSR from all of the STAs triggered by the AP using the same UL-TID Trigger frame. A BSR Requested subfield may be incorporated into the Common Info field of the UL-TID Trigger frame to achieve this.

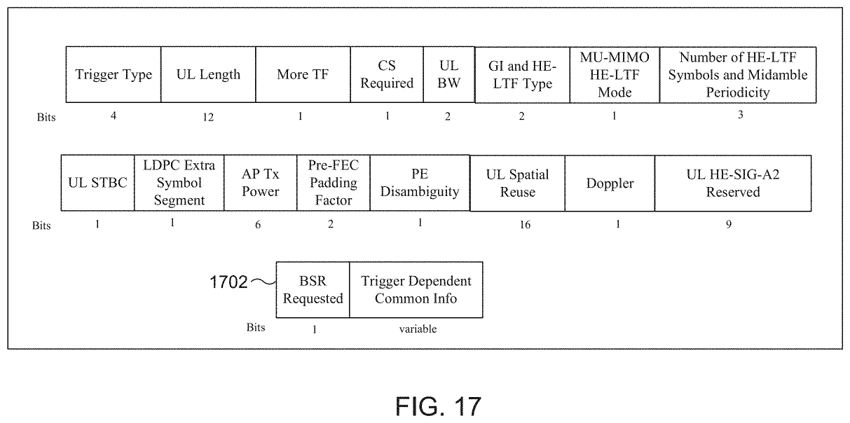

FIG. 17 illustrates an example format of the Common Info field of the UL-TID Trigger frame including a BSR Requested subfield according to various embodiments of the present disclosure. According to one embodiment, if the BSR Requested subfield 1702 of the Common Info field of the UL-TID Trigger frame is set to 1, it indicates that a BSR is solicited from all of the STAs identified by the AID12 subfields of the User Info fields included in the UL-TID Trigger frame. Otherwise, a BSR is not solicited from all triggered STAs.

According to one embodiment, if the BSR Requested subfield 1702 in the Common Info field of the UL-TID Trigger frame is set to 1, then it indicates that BSRs corresponding to all of the TIDs are solicited from the triggered STAs.

According to another embodiment, if the BSR Requested subfield 1702 in the Common Info field of the UL-TID Trigger frame is set to 1, then it indicates that BSRs are requested for those TIDs that are indicated in the Preferred TID subfield or the Preferred TID Bitmap subfield (by setting the corresponding value in the bitmap to 1) in the User Info fields for the respective triggered STAs identified by the AID12 subfields of the UL-TID Trigger frame.

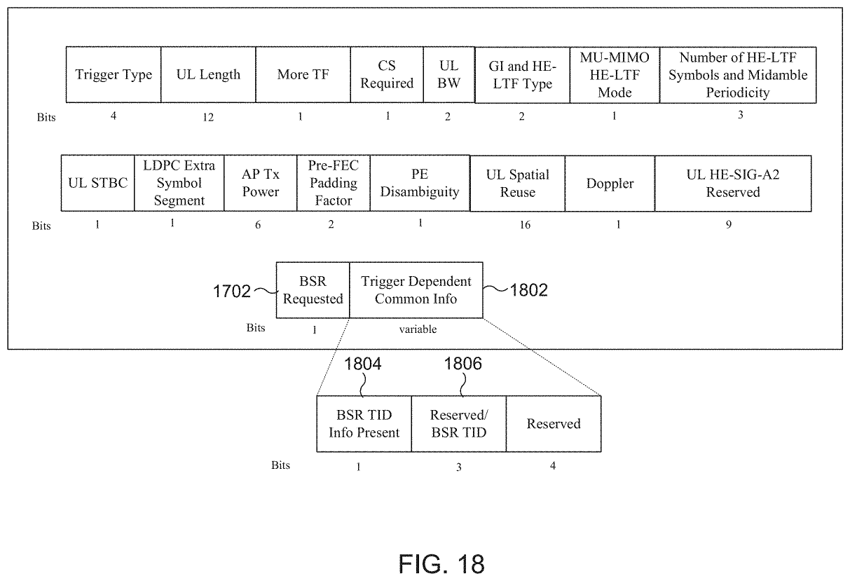

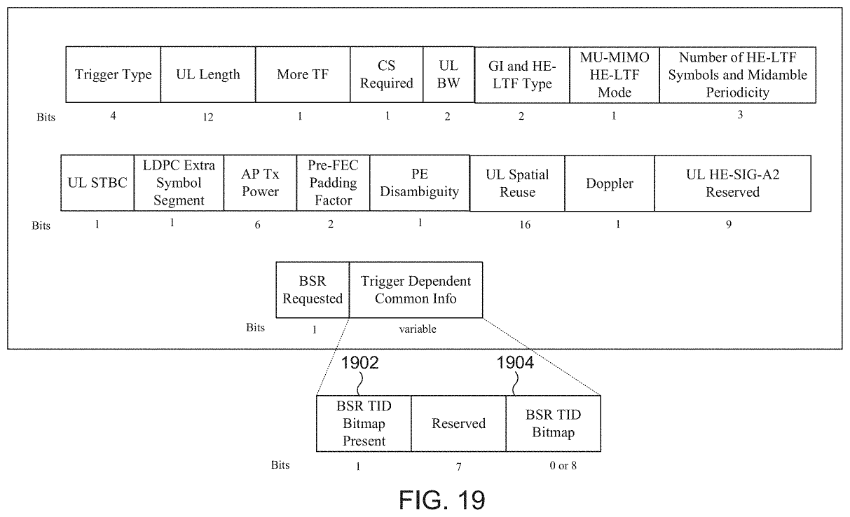

FIG. 18 illustrates another example format of the Common Info field of the UL-TID Trigger frame according to various embodiments of the present disclosure. According to the embodiment of FIG. 18, a Trigger Dependent Common Info field 1802 is optionally present in the Common Info field of the UL-TID Trigger frame. According to one embodiment, the Trigger Dependent Common Info field 1802 is present if BSR Requested subfield 1702 in the Common Info field is set to 1. Otherwise, it is not present. According to another embodiment, the Trigger Dependent Common Info field 1802 is always present in the Common Info field of the UL-TID Trigger frame.

According to one embodiment, in reference to FIG. 18, the BSR TID Info Present subfield 1804 of the Trigger Dependent Common Info field 1802 indicates whether a BSR TID subfield 1806 is present in the Trigger Dependent Common Info field 1802 of the UL-TID Trigger frame. If the BSR TID Info Present subfield 1804 is set to 1, it indicates that the BSR TID subfield 1806 is present in the Trigger Dependent Common Info field 1802. Otherwise, the BSR TID subfield 1806 is not present, and the corresponding bits are reserved.

According to one embodiment, the BSR TID subfield 1806, if present in the Trigger Dependent Common Info field 1802, indicates the TID for which BSRs are solicited from all of the triggered STAs identified by the AID12 subfields in the User Info fields of the UL-TID Trigger frame. According to this embodiment, BSRs related to only one TID can be solicited per UL-TID Trigger frame. According to one embodiment the BSR TID subfield 1806 is 3 bits long, allowing the first 8 TIDs to be indicated. According to another embodiment, the BSR TID subfield 1806 is 4 bits long, allowing all 16 TIDs to be indicated.

FIG. 19 illustrates another example format of the Common Info field of the UL-TID Trigger frame according to various embodiments of the present disclosure. According to one embodiment, in reference to FIG. 19, the BSR TID Bitmap Present subfield 1902 of the Trigger Dependent Common Info field indicates whether BSR TID Bitmap subfield 1904 is present in the Trigger Dependent Common Info field of the UL-TID Trigger frame. If the BSR TID Bitmap Present subfield 1902 is set to 1, it indicates that the BSR TID Bitmap subfield 1904 is present in the Trigger Dependent Common Info field. Otherwise, the BSR TID Bitmap subfield 1904 is not present in the Trigger Dependent Common Info field.

According to one embodiment, the BSR TID Bitmap subfield 1904, if present in the Trigger Dependent Common Info field, indicates the set of TIDs for which BSRs are solicited from all of the triggered STAs identified by the AID12 subfields in the User Info fields of the UL-TID Trigger frame. According to this embodiment, BSRs related to multiple TIDs can be solicited per UL-TID Trigger frame. According to one embodiment, the BSR TID Bitmap subfield 1904 is 8 bits long, allowing the first 8 TIDs to be indicated. According to another embodiment, the BSR TID Bitmap subfield 1904 is 16 bits long, allowing all 16 TIDs to be indicated.

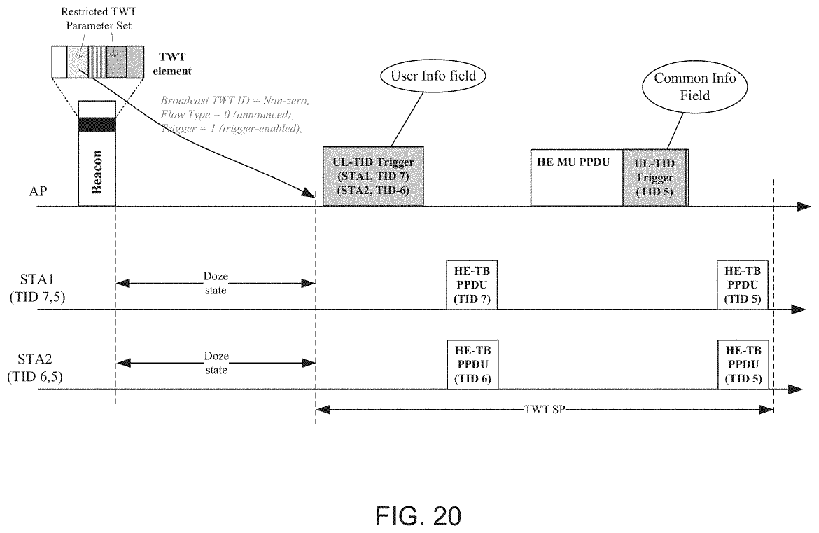

FIG. 20 illustrates an example of using a UL-TID Trigger frame for r-TWT operation using User Info field and Common Info field to indicate the triggered TIDs according to various embodiments of the present disclosure. In contrast to FIG. 14, where the preferred TIDs in the UL-TID Trigger frame are indicated using TID bitmaps, in FIG. 20, the preferred TID is indicated using the Preferred TID subfield. Hence, according to the embodiment of FIG. 20, the indication of only one TID per User Info field or only one TID in the Common Info field is possible, unlike the embodiment of FIG. 14.

According to one embodiment, for restricted TWT operation, during a trigger-enabled r-TWT SP the r-TWT scheduling AP sends a UL-TID Trigger frame that solicits BSRs corresponding to all of the TIDs from the r-TWT member STAs. This may include, for example, TIDs that were not negotiated for transmission during the r-TWT SP.

According to another embodiment, for restricted TWT operation, during a trigger-enabled r-TWT SP, the r-TWT scheduling AP sends a UL-TID Trigger frame that solicits BSRs from the r-TWT member STAs corresponding only to latency-sensitive TIDs for which the triggered r-TWT member STAs have negotiated the r-TWT schedule.

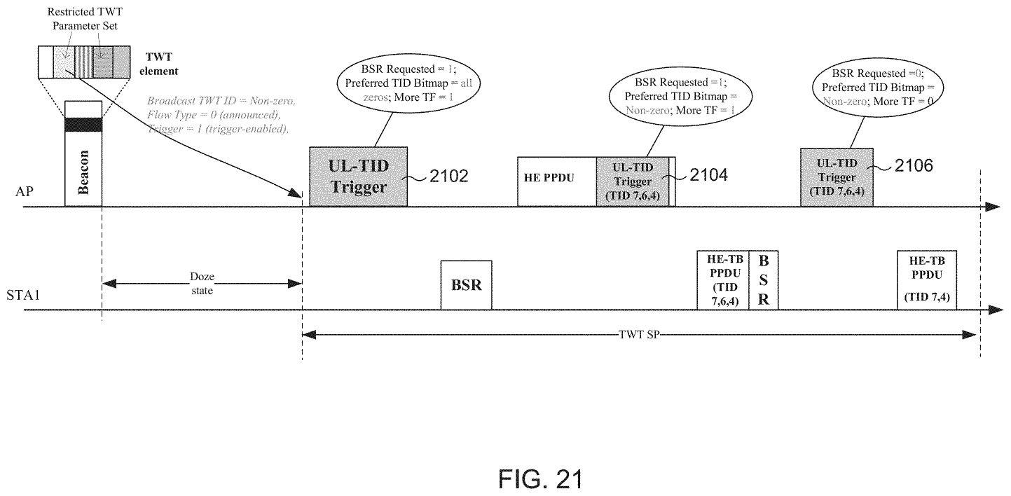

FIG. 21 illustrates an example of using a UL-TID Trigger frame in the context of restricted TWT operation and BSR solicitation according to various embodiments of the present disclosure. In FIG. 21, STA1 may be STA 111 and is associated with the AP. The AP may be AP 101 and is an r-TWT scheduling AP and advertises Restricted TWT schedules in its BSS. STA1 intends to join one of the advertised r-TWT schedules and starts the r-TWT setup process to negotiate the r-TWT schedule with the AP.

STA1 negotiates TIDs 7, 6, and 4 as the latency-sensitive TIDs for transmission during the r-TWT SP. Upon successful establishment of the trigger-enabled restricted TWT schedule, STA1 goes into doze state. STA1 wakes up at the start time of the r-TWT SP. At the beginning of the r-TWT SP, the r-TWT scheduling AP sends a UL-TID Trigger frame 2102 to STAT—in the User Info field of Trigger frame corresponding to STA1, the AP sets the BSR Requested subfield to 1, the Preferred TID Bitmap subfield to all zeros, and the More TF subfield to 1. Accordingly, a SIFS duration later, STA1 sends a BSR corresponding to only the latency-sensitive TIDs negotiated for the r-TWT schedule (i.e., TID 7, TID 6, and TID 4).

Subsequently, the AP sends a downlink HE PPDU to STA1 and includes another UL-TID Trigger frame 2104. In this UL-TID Trigger frame, the AP sets the BSR Requested subfield to 1, the Preferred TID Bitmap subfield to [0, 0, 0, 0, 1, 0, 1, 1], and the More TF subfield to 1. A SIFS duration later, the STA sends an uplink HE TB PPDU with traffic corresponding to TIDs 7, 6, and 4. STA1 also includes the corresponding BSR in the PPDU. In this sent BSR, STA1 indicates that it has non-zero buffer for TIDs 7 and 4, and it has zero-length buffer for TID 6. Subsequently, the AP sends the last UL-TID Trigger frame 2106 to STA1 and indicates TID 7 and TID 4 in the Preferred TID Bitmap subfield. Finally, A SIFS duration later, STA1 sends the uplink PPDU corresponding to TIDs 7 and 4.

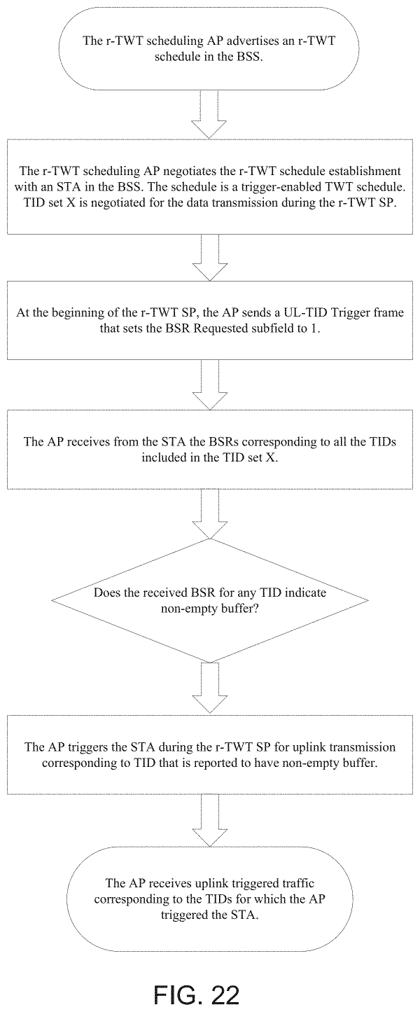

FIG. 22 illustrates an example process for the use of UL-TID Trigger frame including BSR solicitation according to various embodiments of the present disclosure. The example process of FIG. 22 may correspond to the embodiment of FIG. 21.

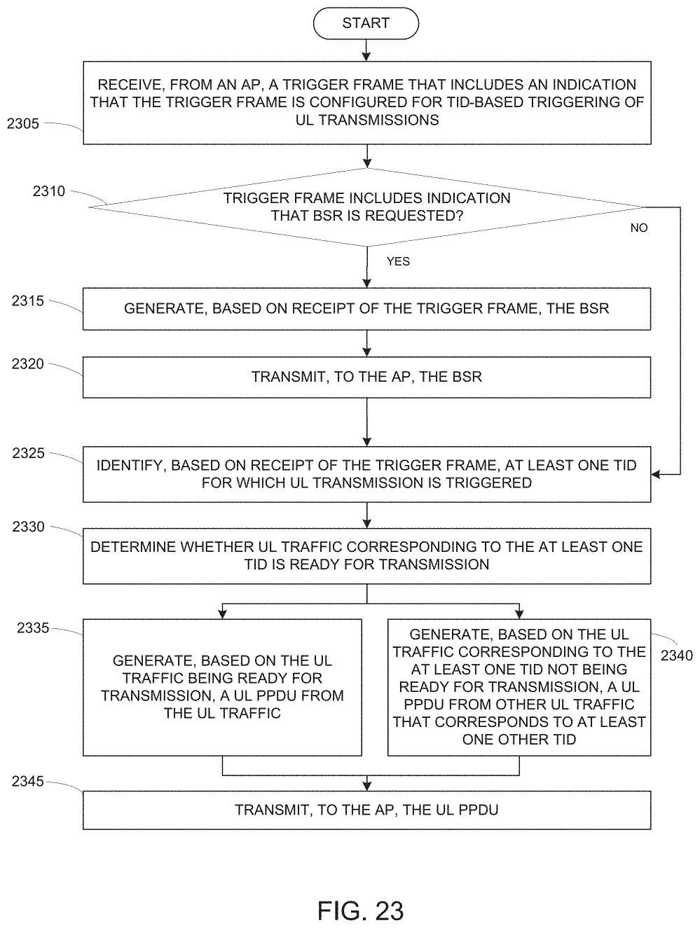

FIG. 23 illustrates an example process for TID-based triggering of uplink transmissions according to various embodiments of the present disclosure. The process of FIG. 23 is discussed as being performed by a STA, but it is understood that an AP associated with the STA could perform a corresponding process. Additionally, for convenience, the process of FIG. 23 is discussed as being performed by a WI-FI STA such as STA 111, but it is understood that any suitable wireless communication device could perform the process.

Referring now to FIG. 23, beginning at step 2305 the STA receives, from an AP, a trigger frame that includes an indication that the trigger frame is configured for TID-based triggering of UL transmissions. In some embodiments, the STA may have established, with the AP, membership in a trigger-enabled TWT schedule that has a TWT SP and at least one associated TID. This may be done in a step that precedes step 2305. In such cases, the STA receives the trigger frame during the TWT SP in step 2305, and the at least one TID indicated in the trigger frame is the at least one TID associated with the trigger-enabled TWT schedule.

If, at step 2310, the STA identifies that the trigger frame includes an indication that a BSR is requested, then the STA proceeds to step 2315, and generates the BSR based on receipt of the trigger frame. The STA may then transmit the BSR to the AP (step 2320).

In some embodiments of step 2310, the STA identifies that the trigger frame includes an indication that the BSR is requested for one or more particular TIDs. In such cases, the STA generates the BSR for the one or more particular TIDs at step 2315.

If the STA does not identify that the trigger frame includes an indication that a BSR is requested (or if the STA does not check for such an indication) at step 2310, then the STA proceeds to step 2325 and identifies, based on receipt of the trigger frame, at least one TID for which UL transmission is triggered.

In some embodiments, the trigger frame includes an indication of the at least one TID. In such cases, the STA identifies the at least one TID indicated in the trigger frame as the at least one TID for which UL transmission is triggered at step 2325.

Next, the STA determines whether UL traffic corresponding to the at least one TID is ready for transmission (step 2330). If the UL traffic is ready for transmission, then the STA generates a UL PPDU from the UL traffic (step 2335). If no UL traffic corresponding to the at least one TID is ready, then in some embodiments the STA generates the UL PPDU from other UL traffic that corresponds to at least one other TID (step 2340).

Finally, the STA transmits, to the AP, the UL PPDU (step 2345).

The above flowchart illustrates an example method that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A station (STA) comprising:
a transceiver configured to receive, from an access point (AP), a trigger frame that includes an indication that the trigger frame is configured for traffic identifier (TID)-based triggering of uplink (UL) transmissions; and
a processor operably coupled to the transceiver, the processor configured to:
identify, based on receipt of the trigger frame, at least one TID for which UL transmission is triggered,
determine whether UL traffic corresponding to the at least one TID is ready for transmission, and
generate, based on the UL traffic being ready for transmission, a UL physical protocol data unit (PPDU) from the UL traffic,
wherein the transceiver is further configured to transmit, to the AP, the UL PPDU.

2. The STA of claim 1, wherein:
the trigger frame includes an indication of the at least one TID, and
the processor is configured to identify the at least one TID indicated in the trigger frame as the at least one TID for which UL transmission is triggered.

3. The STA of claim 1, wherein the processor is further configured to generate, based on the UL traffic corresponding to the at least one TID not being ready for transmission, the UL PPDU from other UL traffic that corresponds to at least one other TID.

4. The STA of claim 1, wherein:
the transceiver is further configured to:
establish, with the AP, membership in a trigger-enabled target wake time (TWT) schedule that has a TWT service period (SP) and at least one associated TID; and
receive the trigger frame during the TWT SP, and
the at least one TID indicated in the trigger frame is the at least one TID associated with the trigger-enabled TWT schedule.

5. The STA of claim 1, wherein:
the trigger frame includes an indication that a buffer status report (BSR) is requested,
the processor is further configured to generate, based on receipt of the trigger frame, the BSR, and
the transceiver is further configured to transmit, to the AP, the BSR.

6. The STA of claim 5, wherein:
the trigger frame includes an indication that the BSR is requested for one or more particular TIDs, and
the processor is further configured to generate, based on receipt of the trigger frame, the BSR for the one or more particular TIDs.

7. The STA of claim 1, wherein:
the trigger frame includes an indication of resource units (RUs) that are allocated for a random access procedure and an indication that the at least one TID is associated with at least one of the RUs, and
the transceiver is further configured to transmit, to the AP, the UL PPDU on one of the RUs associated with the at least one TID.

8. An access point (AP) comprising:
a transceiver; and
a processor operably coupled to the transceiver, the processor configured to generate a trigger frame that includes an indication that the trigger frame is configured for traffic identifier (TID)-based triggering of uplink (UL) transmissions,
wherein the transceiver is configured to transmit, to a station (STA), the trigger frame,
wherein, based on receipt of the trigger frame by the STA, at least one TID is identified for which UL transmission is triggered,
wherein it is determined whether UL traffic corresponding to the at least one TID is ready for transmission,
wherein, based on the UL traffic being ready for transmission, a UL physical protocol data unit (PPDU) is generated from the UL traffic, and
wherein the transceiver is further configured to receive, from the STA, the UL PPDU.

9. The AP of claim 8, wherein:
the trigger frame includes an indication of the at least one TID, and
the at least one TID indicated in the trigger frame is identified as the at least one TID for which UL transmission is triggered.

10. The AP of claim 8, wherein, based on the UL traffic corresponding to the at least one TID not being ready for transmission, the UL PPDU is generated from other UL traffic that corresponds to at least one other TID.

11. The AP of claim 8, wherein:
the transceiver is further configured to:
establish, with the STA, membership in a trigger-enabled target wake time (TWT) schedule that has a TWT service period (SP) and at least one associated TID; and
transmit the trigger frame during the TWT SP, and
the at least one TID indicated in the trigger frame is the at least one TID associated with the trigger-enabled TWT schedule.

12. The AP of claim 8, wherein:
the trigger frame includes an indication that a buffer status report (BSR) is requested,
the BSR is generated based on the receipt of the trigger frame, and
the transceiver is further configured to receive, from the STA, the BSR.

13. The AP of claim 12, wherein:
the trigger frame includes an indication that the BSR is requested for one or more particular TIDs, and
based on receipt of the trigger frame, the BSR is generated for the one or more particular TIDs.

14. The AP of claim 8, wherein:
the trigger frame includes an indication of resource units (RUs) that are allocated for a random access procedure and an indication that the at least one TID is associated with at least one of the RUs, and
the transceiver is further configured to receive, from the STA, the UL PPDU on one of the RUs associated with the at least one TID.

15. A method for wireless communication performed by a station (STA), the method comprising:
receiving, from an access point (AP), a trigger frame that includes an indication that the trigger frame is configured for traffic identifier (TID)-based triggering of uplink (UL) transmissions;
identifying, based on receipt of the trigger frame, at least one TID for which UL transmission is triggered;
determining whether UL traffic corresponding to the at least one TID is ready for transmission;
generating, based on the UL traffic being ready for transmission, a UL physical protocol data unit (PPDU) from the UL traffic; and
transmitting, to the AP, the UL PPDU.

16. The method of claim 15, wherein:
the trigger frame includes an indication of the at least one TID, and
identifying the at least one TID for which UL transmission is triggered comprises identifying the at least one TID indicated in the trigger frame as the at least one TID for which UL transmission is triggered.

17. The method of claim 15, further comprising generating, based on the UL traffic corresponding to the at least one TID not being ready for transmission, the UL PPDU from other UL traffic that corresponds to at least one other TID.

18. The method of claim 15, further comprising:
establishing, with the AP, membership in a trigger-enabled target wake time (TWT) schedule that has a TWT service period (SP) and at least one associated TID; and
receiving the trigger frame during the TWT SP,
wherein the at least one TID indicated in the trigger frame is the at least one TID associated with the trigger-enabled TWT schedule.

19. The method of claim 15, wherein:
the trigger frame includes an indication that a buffer status report (BSR) is requested, and
the method further comprises:
generating, based on receipt of the trigger frame, the BSR; and
transmitting, to the AP, the BSR.

20. The method of claim 15, wherein:
the trigger frame includes an indication of resource units (RUs) that are allocated for a random access procedure and an indication that the at least one TID is associated with at least one of the RUs, and
the method further comprises transmitting, to the AP, the UL PPDU on one of the RUs associated with the at least one TID.
